(19) United States
(12) Patent Application Publication
(10) Pub. No.: US 2014/0183185 A1
(43) Pub. Date: Jul. 3, 2014

(54) TUNED POWER AMPLIFIER WITH LOADED CHOKE FOR INDUCTIVELY HEATED FUEL INJECTOR

(71) Applicant: Continental Automotive Systems, Inc., Auburn Hills, MI (US)

(72) Inventor: Perry Robert Czimmek, Williamsburg, VA (US)

(21) Appl. No.: 14/134,774

(22) Filed: Dec. 19, 2013

Related U.S. Application Data
(60) Provisional application No. 61/747,501, filed on Dec. 31, 2012.

(51) Int. Cl. H05B 6/08

(52) U.S. Cl. CPC H05B 6/08
USPC 219/666

(57) ABSTRACT

A tuned power amplifier includes: a tuning capacitor connected in series with a loaded choke that represents an inductance of an oscillator, and a semiconductor power switch connected to the series connection between the tuning capacitor and the loaded choke. The loaded choke may be an induction heating coil of an inductively heated fuel injector. The induction heating coil or the tuning capacitor may be connected to a voltage source. An on state and an off state of the semiconductor power switch may be synchronized with, or at a frequency below, a natural resonant frequency of the tuned power amplifier.

### CROSS-REFERENCE TO RELATED APPLICATIONS

This application is related to the following 5 U.S. provisional patent applications:

Using Resistance Equivalent to Estimate Temperature of a Fuel-Injector Heater, invented by Perry Czimmek, Mike Hornby, and Doug Cosby, filed on the same day as this provisional patent application, and identified by Attorney Docket Number 2012P01913US.

Tuned Power Amplifier with Multiple Loaded Chokes for Inductively Heated Fuel Injectors, invented by Perry Czimmek, filed on the same day as this provisional patent application, and identified by Attorney Docket Number 2012P01915US.

Using Resistance Equivalent to Estimate Heater Temperature of an Exhaust Gas After-Treatment Component, invented by Perry Czimmek, Mike Hornby, and Doug Cosby, filed on the same day as this provisional patent application, and identified by Attorney Docket Number 2012P02060US.

Resistance Determination For Temperature Control Of Heated Automotive Components, invented by Perry Czimmek, filed on the same day as this provisional patent application, and identified by Attorney Docket Number 2012P02175US.

Resistance Determination with Increased Sensitivity for Temperature Control of Heated Automotive Component, invented by Perry Czimmek, filed on the same day as this provisional patent application, and identified by Attorney Docket Number 2012P02176US.

### BACKGROUND

Embodiments of the invention relate generally to power electronics for induction heaters and more particularly for induction heater drivers for variable spray fuel injectors.

There is a continued need for improving the emissions quality of internal combustion engines. At the same time, there is pressure to minimize engine crank times and time from key-on to drive-away, while maintaining maximum fuel economy. These pressures apply to engines fueled with alternative fuels, such as ethanol, as well as to those fueled with gasoline.

During cold temperature engine start, the conventional spark ignition internal combustion engine is characterized by high hydrocarbon emissions and poor fuel ignition and combustibility. Unless the engine is already at a high temperature after stop and hot-soak, the crank time may be excessive, or the engine may not start at all. At higher speeds and loads, the operating temperature increases and fuel atomization and mixing improve.

During an actual engine cold start, the enrichment necessary to accomplish the start leaves an off-stoichiometric fueling that materializes as high tail-pipe hydrocarbon emissions. The worst emissions are during the first few minutes of engine operation, after which the catalyst and engine approach operating temperature. Regarding ethanol fueled vehicles, as the ethanol percentage of the fuel increases to 100%, the ability to cold start becomes increasingly diminished, leading some manufacturers to include a dual fuel system in which engine start is fueled with conventional gasoline, and engine running is fueled with the ethanol grade. Such systems are expensive and redundant.

Another solution to cold start emissions and starting difficulty at low temperature is to pre-heat the fuel to a temperature where the fuel vaporizes quickly, or vaporizes immediately (“flash boils”), when released to manifold or atmospheric pressure. Pre-heating the fuel replicates a hot engine as far as fuel state is considered.

A number of pre-heating methods have been proposed, most of which involve preheating in a fuel injector. Fuel injectors are widely used for metering fuel into the intake manifold or cylinders of automotive engines. Fuel injectors typically comprise a housing containing a volume of pressurized fuel, a fuel inlet portion, a nozzle portion containing a needle valve, and an electromechanical actuator such as an electromagnetic solenoid, a piezoelectric actuator, or another mechanism for actuating the needle valve. When the needle valve is actuated, the pressurized fuel sprays out through an orifice in the valve seat and into the engine.

One technique that has been used in preheating fuel is to inductively heat metallic elements of the fuel injector with a time-varying magnetic field. Exemplary fuel injectors having induction heating are disclosed in U.S. Pat. No. 7,677,468, U.S. Patent Application Publications: 20070235569, 20070235086, 20070221874, 20070221761 and 20070221747, the contents of which are hereby incorporated by reference herein in their entirety. The energy is converted to heat inside a component suitable in geometry and material to be heated by the hysteretic and eddy-current losses that are induced by the time-varying magnetic field.

The heated fuel injector is useful not only in solving the above-described problems associated with gasoline systems, but is also useful in pre-heating ethanol grade fuels to accomplish successful starting without a redundant gasoline fuel system.

Because the induction heating technique uses a time-varying magnetic field, the system includes electronics for providing an appropriate high frequency alternating current to an induction coil in the fuel injector.

Conventional induction heating is accomplished with hard-switching of power, or switching when both voltage and current are non-zero in the switching device. Typically, switching is done at a frequency near the natural resonant frequency of a resonator, or tank circuit. The resonator includes an inductor and capacitor that are selected and optimized to resonate at a frequency suitable to maximize energy coupling into the heated component.

The natural resonant frequency of a tank circuit is fr=1/(2π\sqrt{LC}), where L is the circuit inductance, and C is the circuit capacitance. The peak voltage at resonance is limited by the energy losses of the inductor and capacitor, or decreased quality factor, Q, of the circuit. Hard-switching can be accomplished with what are called half-bridge or full-bridge circuits, comprising a pair, or two pairs, of semiconductor switches, respectively. Hard-switching of power results in the negative consequences of switching noise, and high amplitude current pulses at resonant frequency from the voltage supply, or harmonics thereof. Also, hard switching dissipates power during the linear turn-on and turn-off period when the switching device is neither fully conducting nor fully insulating. The higher the frequency of a hard-switched circuit, the greater the switching losses.

A conventional heater circuit that drives a heated fuel injector wherein switching is done at the lowest possible interrupted power was disclosed in U.S. Pat. No. 7,628,340, entitled Constant Current Zero-Voltage Switching Induction Heater Driver for Variable Spray Injection. Ideally, energy should be replenished to the tank circuit when either the voltage or the current in the switching device is zero. It is known that the electromagnetic noise is lower during zero-voltage or zero-current switching, and is lowest during zero-voltage switching, this is utilized in U.S. Pat. No. 7,628,340. It is also known that the switching device dissipates the least power under zero switching. That ideal switching point occurs twice per cycle when the sine wave crosses zero and reverses polarity; i.e., when the sine wave crosses zero in a first direction from positive to negative, and when the sine wave crosses zero in a second direction from negative to positive.

An additional method of driving a heated fuel injector wherein switching is done at the lowest possible interrupted power is disclosed in U.S. Patent Publication 20120267359, invented by Perry Czimmek, entitled Synchronous Full-Bridge Power Oscillator. The disclosed topology uses two pairs of complimentary pairs of power switching transistors in a modified full-bridge, or H-bridge, configuration. The deviation from a full-bridge driver is that the bridge is fed from a constant-current source inductor, and the load section of the conventional full bridge is replaced with the resonant tank circuit. Further deviation from a conventional full-bridge is the oscillator-synchronous inherent zero-switching topology that drives the gates of the complimentary pairs of transistors in alternating sequence of diagonal pairs.

Improved techniques for driving a heated fuel injector wherein switching is done at the lowest possible interrupted power would advance the state of the art.

### BRIEF SUMMARY

Embodiments of the invention are directed to a tuned power amplifier that includes: a tuning capacitor connected in series with a loaded choke that represents an inductance of an oscillator, and a semiconductor power switch connected to the series connection between the tuning capacitor and the loaded choke. The loaded choke may be an induction heating coil of an inductively heated fuel injector. The induction heating coil or the tuning capacitor may be connected to a voltage source. An on state and an off state of the semiconductor power switch may be synchronized with, or at a frequency below, a natural resonant frequency of the tuned power amplifier.

### BRIEF DESCRIPTION OF THE DRAWINGS

FIG. 1 is a simplified electrical schematic diagram of a conventional load placement of a Class E or Class F amplifier.

FIG. 2 is a simplified electrical schematic diagram of a tuned power amplifier in accordance with embodiments of the invention.

FIG. 3 is a diagram of a SPICE simulation of a tuned power amplifier in accordance with embodiments of the invention.

FIG. 4 is an example plot of a simulation result for a set of conditions of the tuned power amplifier of FIG. 3.

FIG. 5 is a schematic diagram of a prototype hardware implementation of a tuned power amplifier in accordance with embodiments of the invention.

FIG. 6 is an oscilloscope plot of measured signals from the tuned power amplifier of FIG. 5.

### DETAILED DESCRIPTION

Embodiments of the invention are directed to driving a heated fuel injector wherein switching is done at the lowest possible interrupted power via a reduced number of electronic components, which results in cost savings associated with reduction of component count while still accomplishing switching at the lowest possible interrupted power.

Embodiments of the invention are directed to modifying a Class E/F amplifier with radio frequency choke by substituting the load as part of the radio frequency choke in order to accomplish inductive heating of the loaded loss component.

Embodiments of the invention eliminate the conventional position of the load and load inductor and substitute the radio frequency choke with a choke that comprises the load inductor and load as the heater coil of an inductively heated fuel injector. In this way, a dedicated radio frequency choke, which is typically required by conventional methods, is no longer required.

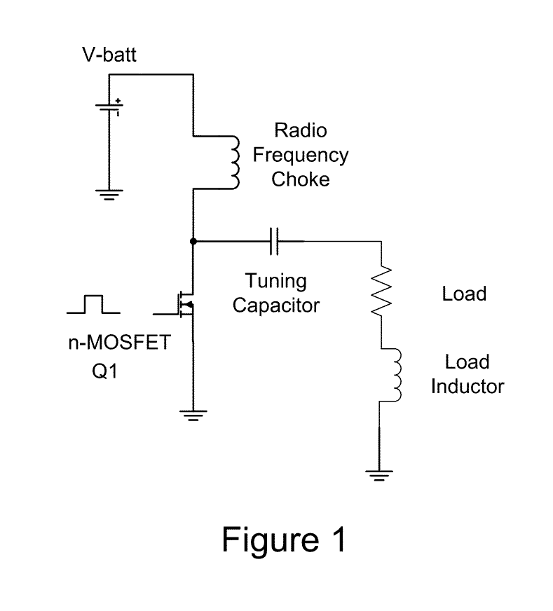

Class E, E/F, and F amplifiers are, for practical purposes, described as tuned switch mode inverters that convert direct current into alternating current. The efficiency is relatively high with Class E, E/F, and F amplifiers, and their conduction of the power switch is usually close to 50%. Their conduction is selected to be switched on and off in synchronization with the natural resonance of one or more tuned circuits comprising an inductive component and a capacitive component. The tuned circuit is conventionally located in parallel or series with the load component. FIG. 1 depicts a load in series with the tuned circuit in a conventional manner. A separate radio frequency choke is included to provide a replenishment of the energy lost in the tuned circuit and load. A radio frequency choke is not conventionally part of this tuned circuit, nor is it a loss component for the purposes of induction heating. Embodiments of the invention combine the radio frequency choke with the loss component for purposes of induction heating. In this way, the choke, its inherent effect on its own self inductance, and the tuning capacitor are what remain for tuning.

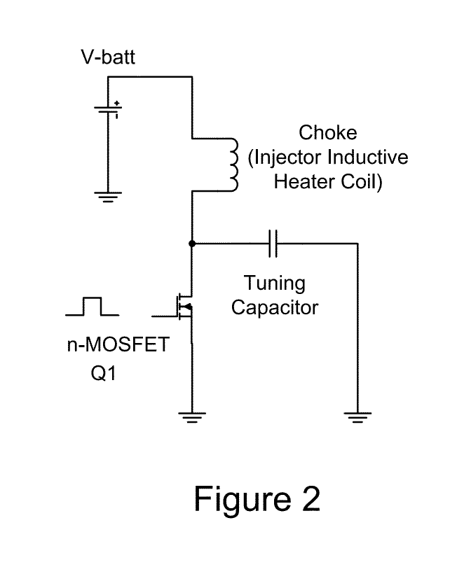

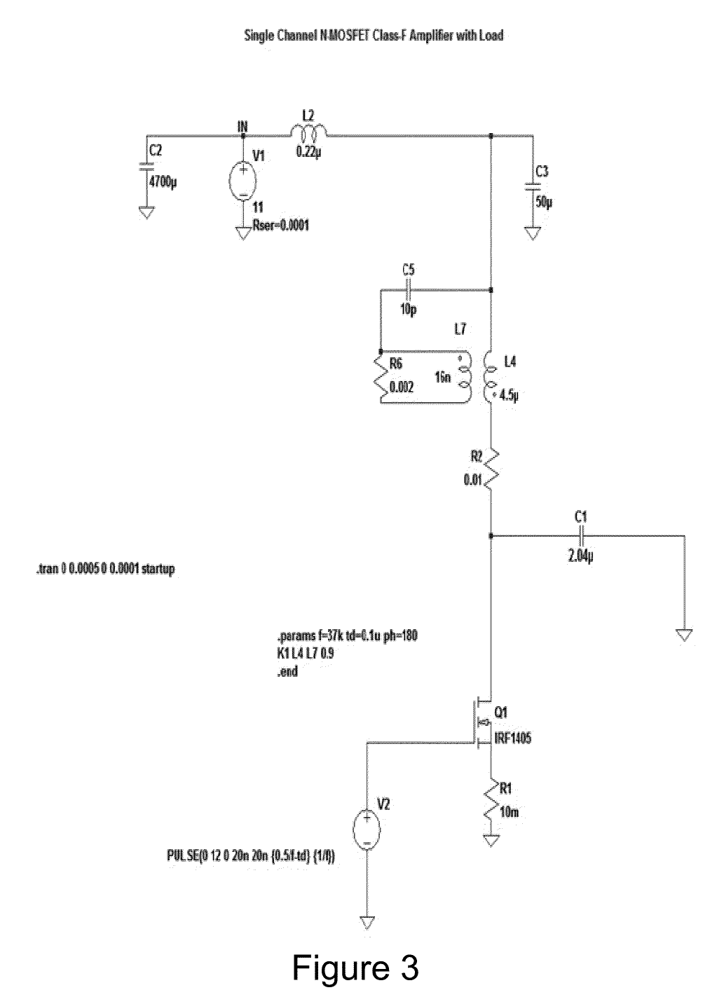

Embodiments of the invention eliminate the conventional position of the load and load inductor and substitute the radio frequency choke with a choke that now comprises the load inductor and load as the heater coil of an inductively heated injector as is shown in FIG. 2. This substitution is made clear in the equivalent circuit of the SPICE model of FIG. 3 where the load and load inductor are represented in their new location, in accordance with embodiments of the invention, by resistor R6 and inductor L4:L7, respectively. A dedicated radio frequency choke, as is typically required by conventional methods, is not needed. Likewise, additional power switches are also not needed, such that a tuned power amplifier, in accordance with embodiments of the invention, can operate with a single n-MOSFET. In this way, a resonant network may be formed between the choke, or load inductor, and the tuning capacitor.

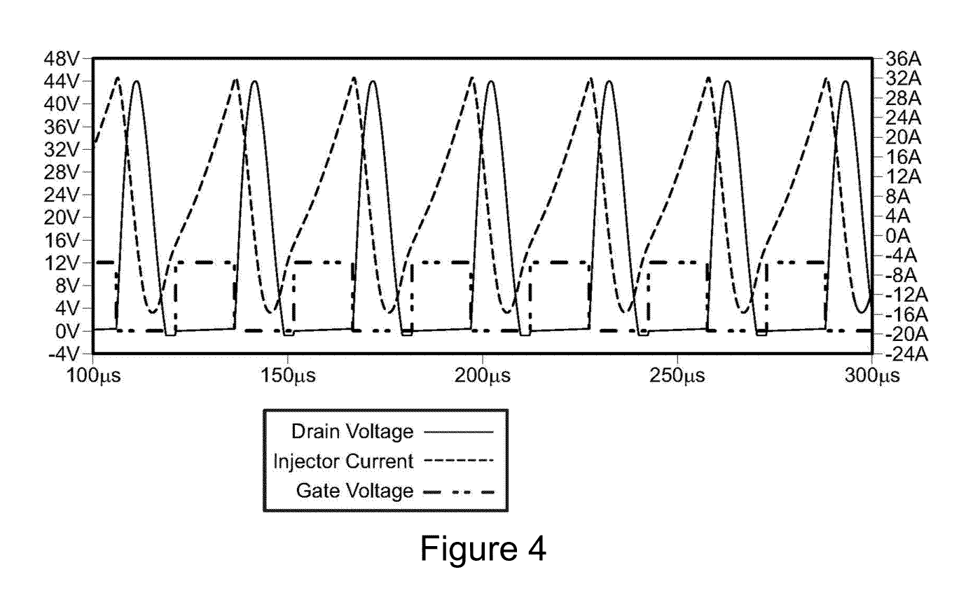

Ideally, energy should be replenished to the tank circuit when either the voltage or the current in the switching device is zero. It is known that the electromagnetic noise is lower during zero-voltage or zero-current switching, and is lowest during zero-voltage switching. It is also known that the switching device dissipates the least power under zero switching. The energy replenishment is enabled by semiconductor switches, and the zero-voltage switching is synchronized with the resonance of the tuned circuit. This is affirmed by the results of simulation, shown in FIG. 4, where switching points are synchronized with the drain voltage, which is also the capacitor voltage.

The tuning capacitor and choke form the tuned circuit. The resonant frequency of the tuned circuit is fr=1/(2π\sqrt{LC}), where L is the inductance of the choke, and C is the capacitance of the tuning capacitor. The peak voltage in the tuned circuit is close to the relation Vₒᵤₜ=π*Vᵢₙ where Vᵢₙ is the supply voltage. The current level in the tuned circuit is determined from the energy balance of

$$\frac{1}{2} {LI}^{2} = \frac{1}{2} {CV}^{2} .$$

The loading caused by the resistive and hysteretic loss of the heated component inside of the injector heating coil of the choke reflects back as a loss in the tuned circuit. That loss is replenished by current flowing into the choke from the supply voltage in accordance with embodiments of the invention. The choke also provides transient separation of the tuned circuit from the voltage source such that the tank voltage may be instantaneously higher than the source voltage during oscillation.

Temperature control may be performed by interrogating the tuned frequency from the parameter, such as the time varying gate charge of one or more of the oscillator power switches. This method utilizing gate charge to determine tank frequency has been previously disclosed in U.S. Patent Application Publication 20100288755, invented by Perry Czimmek, entitled Frequency to Voltage Converter Using Gate Voltage Sampling of Power Oscillator, the entire contents of which are hereby incorporated by reference.

FIG. 3 is a diagram of a SPICE simulation of a tuned power amplifier in accordance with embodiments of the invention.

FIG. 4 is an example plot of a simulation result for a set of conditions of the tuned power amplifier of FIG. 3. FIG. 4 shows the drain voltage of Q1, which is one lead of the MOSFET switch. The gate voltage is V2, which would be the voltage that is turning on and off the MOSFET Q1. The current is the current that is flowing through L4, which is the load inductor, or the radio frequency choke component. FIG. 4 shows the time varying current, which is the injector current. It has a DC bias. It goes up to 32 amps, and down to −16 amps. This time-varying current generates the time-varying field in the load inductor, which generates heat, and the simulation shows that the circuit of FIG. 3 operates as intended.

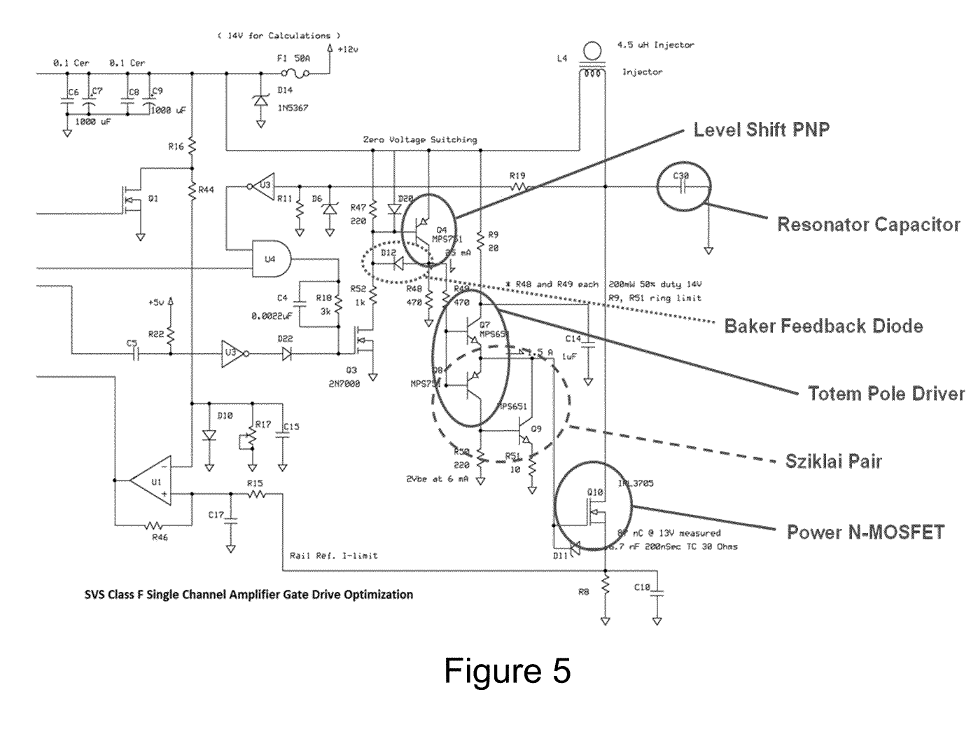

FIG. 5 is a schematic diagram of a prototype hardware implementation of a tuned power amplifier in accordance with embodiments of the invention. Depicted components include a level shift PNP, a resonator capacitor, a Baker feedback diode, a totem pole driver, a Sziklai pair, and a power MOSFET. U1 is an operational amplifier that measures current through the load. A signal coming in on the inverting Schmitt trigger, U3, is a signal for getting the oscillator started. An and gate, U4, provides a signal for maintaining operation of the amplifier.

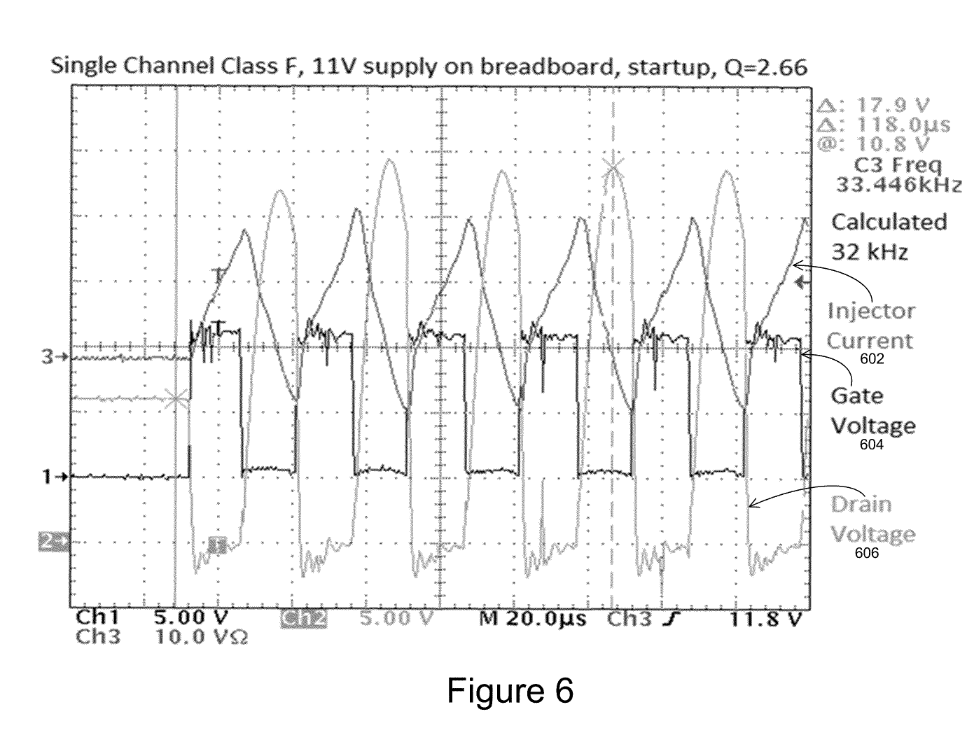

FIG. 6 is an oscilloscope plot of measured signals from the tuned power amplifier of FIG. 5. FIG. 6 shows that the tuned power amplifier and circuit of FIG. 5 operate as intended with a reduced component count, which in turn results in a reduced cost of implementation.

The foregoing detailed description is to be understood as being in every respect illustrative and exemplary, but not restrictive, and the scope of the invention disclosed herein is not to be determined from the description of the invention, but rather from the claims as interpreted according to the full breadth permitted by the patent laws. For example, while the method makes reference to a specific class of amplifier as understood by those skilled in the art, variations may be used with other amplifier classes or with no reference to amplifier class at all. It is to be understood that the embodiments shown and described herein are only illustrative of the principles of the present invention and that various modifications may be implemented by those skilled in the art without departing from the scope and spirit of the invention.

1. A tuned power amplifier comprising:
a tuning capacitor connected, in series, at a series connection, with a loaded choke, wherein the loaded choke is configured to represent an inductance of an oscillator; and
a semiconductor power switch connected to the series connection between the tuning capacitor and the loaded choke.

2. The tuned power amplifier of claim 1, wherein the loaded choke comprises an electromagnetic coil and a loss component configured to perform induction heating.

3. The tuned power amplifier of claim 1, wherein the loaded choke comprises an induction heating coil of an inductively heated fuel injector.

4. The tuned power amplifier of claim 3, wherein the induction heating coil is connected to a voltage source.

5. The tuned power amplifier of claim 3, wherein the tuning capacitor is connected to a voltage source.

6. The tuned power amplifier of claim 1, wherein an on state of the semiconductor power switch and an off state of the semiconductor power switch are synchronized with a natural resonant frequency of the tuned power amplifier.

7. The tuned power amplifier of claim 1, wherein an on state of the semiconductor power switch and an off state of the semiconductor power switch are synchronized at a frequency below a natural resonant frequency of the tuned power amplifier.
